(19) United States
(12) Patent Application Publication
(10) Pub. No.: US 2007/0077117 A1
(43) Pub. Date: Apr. 5, 2007

(54) Mortise and tenon joint system

(76) Inventors: Alan Vu, Westbrook, CT (US); Gregory Budzian, New Britain, CT (US); Arthur D. Ritone JR., Newington, CT (US)

Correspondence Address: SILLS CUMMIS EPSTEIN & GROSS P.C., ONE RIVERFRONT PLAZA, IP DEPARTMENT, NEWARK, NJ, 07102, US

(21) Appl. No.: 11/634,395

(22) Filed: Dec. 5, 2006

Related U.S. Application Data
(63) Continuation-in-part of application No. 11/035,664, filed on Jan. 14, 2005, now abandoned.
(60) Provisional application No. 60/481,912, filed on Jan. 16, 2004.

(51) Int. Cl. B25G 3/36; E06B 3/984

(52) U.S. Cl. 403/401

(57) ABSTRACT

The invention provides a joint and a method for forming a joint between two structural elements comprising a tenon on a mitered edge of a first structural element joined to an oppositely corresponding mortise on a mitered edge of a second structural element. The tenon is sized so that its insertion in the mortise of a corresponding structural element allows lateral movement to fit around imperfect door and window jambs. The lateral movement of the corresponding structural elements facilitates proper alignment of the joint and elimates any gaps between the structural elements.

### CROSS REFERENCE TO RELATED APPLICATIONS

The present application is Continuation-In-Part (CIP) of non-provisional application Ser. No. 11/035,644, filed Jan. 14, 2005, which claims the benefit of prior U.S. Provisional Application No. 60/481,912, filed Jan. 16, 2004

### FIELD OF THE INVENTION

This invention relates generally to structural systems and a joint for joining structural elements together as a building material. More particularly, the joint is for trim moulding or stationary framework that is mitered on opposite ends to form a mortise or tenon.

### BACKGROUND OF THE INVENTION

Many types of joints for structural elements exist. A simple butt joint is formed by nailing or screwing two ends together. This joint is formed by nailing or screwing the end of one piece of wood to the end of the other. While this is simple, fast and effective, the butt joint cannot be used on many types of end joints since it is not strong. A simple butt joint also leaves the heads of the fasteners exposed which is often undesirable.

Another type of joint is the end lap joint. This joint is made by removing substantially halfway through each piece of structural element. That is, chamfering the ends of structural elements, and securing them together. Typically, the ends are glued with an adhesive or fastened together with a fastener. This is a common type of joint used in picture frames. The problem with this type of joint is that it does not withstand shear forces very well, and any force on the structure will impart shear forces on the joint. Glued joints of this type are also weak due to the shear forces.

A rabbet joint has become a standard design for many applications that utilize extended tab and pocket cutout joinery. In a rabbet joint, the pocket cutouts are at the very edge of the panel, with the pocket sidewalls actually incorporated into the outer edge of the panel. Rabbet joints are commonly found in simple box and case construction. A rabbet is typically an L-shaped groove cut across the edge or end of one structural element. Fitting the other piece into it makes the joint. The rabbet joint is usually fastened with glue and nails or screws. This type of joint permits joint location to occur at the edge of a panel, thus providing the benefit of a non-interfering edge profile. The disadvantage of the rabbet joint, is that the joint must be adhesive bonded to secure the panel connection, and the primary load path is through the relatively weak adhesive bondline at the rabbet joint.

The dado is used to provide a supporting ledge for a shelf. The dado is a groove cut across the grain. In the simple dado joint, the butt end of the piece or shelf fits into this groove. The problem with this joint is that, unless a face frame is added to the front of the case, it has an unattractive look. For better appearance, a stopped or blind dado is the very best. In this joint, a dado is cut partway across the first piece, and then a corner is notched out of the second piece so the two fit together.

An alternate to the joint mentioned is referred to as a mortise and tenon joint. To form this joint, a slot is placed in one structural element. The end of the other structural element is then notched out to correspondingly fit the slot in the first piece. One inserts the notched piece into the slotted piece of the structural element. An open mortise and tenon joint is made by cutting the slot or mortise only partway into the structural element. Then create a notched-out area on the other piece that correspondingly fits into the slotted area in the first piece.

The bonding process of a mortise and tenon joint may involve applying adhesive into the mortise pocket, however, since the pocket is fully enclosed in the mortise panel (not incorporated into the panel edge as in the rabbet joint), the primary load path is through the mortise panel itself and not the adhesive bondline. The disadvantage of the mortise and tenon joint is the existence of an edge margin of the mortise panel that extends from the mortise pocket to the actual edge of the panel. This interfering edge margin reduces the volume which can be achieved inside a defined envelope.

Typically, relatively large clearances must be designed into mortise and tenon joint interfaces so that costly interference conditions do not occur, preventing the tenon tabs from fitting into the mortise pockets, and resulting in the scrapping of parts or expensive rework. These large clearances between the mortise pocket sidewalls and the tenon tab surfaces, increase the need for elaborate and expensive tooling to accurately locate and secure the panels. While the panels are held in place, an adhesive, which is used to bond the joint, is allowed the necessary time to cure. A joint structure with inherent self-tooling features that could eliminate the need for expensive additional tooling is highly desirable.

### SUMMARY OF THE INVENTION

This invention provides an improved mortise and tenon joint. The joint is a stopped or blind mortise and tenon joint where the tenon is hidden fully in the mortise. In the preferred embodiment of the present invention, a first and second trim moulding is constructed as a mortise and tenon. In the preferred embodiment, the tenon is perpendicular to the miter edge. The tenon preferably has a thickness of approximately ⅓ that of the moulding at the middle of the miter. The width is approximately ½ the width of the joint. The height is approximately equal to the mortise depth and preferably less approximately ¼ inch.

The tenon has a glue relief on the back side. In the preferred embodiment, the tenon is produced on the vertical side of the trim, but can be produced on the horizontal as well. The mortise can be produced on the vertical or horizontal as well. By consistently producing the mortise in one configuration and the tenon in the other, identifying the vertical and horizontal structural elements is easier. The mortise is designed to receive the tenon in a tight, close fit such that the friction between the mortise and tenon hold the structural elements together under the expected stress and forces. The depth of the mortise may vary depending on the materials, design preferences, strength desired as well as other factors. Preferably it is designed to come within ¼ inch of the outside surface of the finish moulding, and thus is unique to a particular size and style of moulding.

The purpose of the mortise and tenon on the miter of the vertical and horizontal joining of the structural elements is: (1) to maximize the surface area of contact in the joining; (2) to assure that the joining parts do not move independently of each other; and (3) to assure the precise alignment in the joining of the mitered edges to produce a quality joint by the end user at the time of application with minimal amount of skill and time.

### BRIEF DESCRIPTION OF THE DRAWINGS

FIG. 1 is a plan view of a tenon of the present invention;

FIG. 2 is an elevational view of a tenon of the present invention;

FIG. 3 is a schematic view of an embodiment of the present invention;

FIG. 4 is a schematic view of the tenon and structural element; and

FIG. 5 is a schematic view of the mortise and structural element.

### DETAILED DESCRIPTION OF THE INVENTION

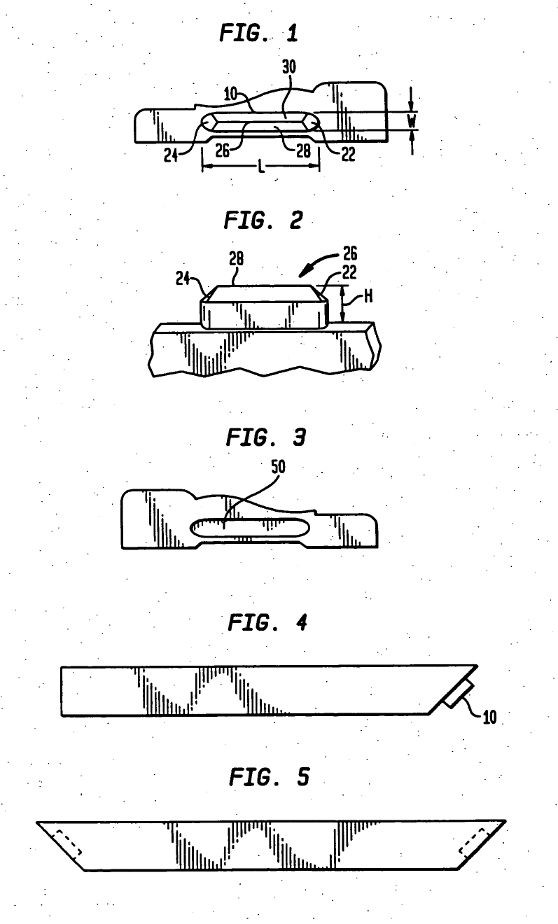

The present invention provides an improved mortise and tenon joint system. In FIG. 1, a side view schematic of the tenon is depicted. In this embodiment, the tenon 10 is generally oval or oblong with two opposing ends 22, 24 and a center portion 26. The ends (or “faces”) 22, 24 are shaped to extend in a slope (tapered fashion) upwards toward the center portion 26 as shown in FIG. 2. The center portion 26 comprises opposing sides 28,30 that slope up towards, and meet at, a middle 28. The tenon may be of other known shapes and is not limited to this preferred design.

The proper proportion between the overall length and height of the tendon compared to the overall size and shape of the structural element is generally known in the art. In the embodiment shown in FIG. 1, the size is approximately 31.75 mm in length and 4.76 mm in width and, as shown in FIG. 2, 12.7 mm in height. The size is generally determined by the structural elements being joined, which in this case are window or door mouldings. The constraints include but are not limited to the weight and shear forces acting on the joint as well as the amount of material available to form the mortise and tenon. These factors will help determine the dimensions (length, width, height) of the tenon.

FIG. 3 is a side plan view of the mortise 50 of the present invention. As is known in the art, the mortise is designed to generally correspond to the shape and size of the tenon, although they do not have to correspond exactly. In the example shown in FIG. 3, the mortise is oval or oblong and slightly larger in dimensions than the tenon, the walls do not slope and the bottom is planar. The size is intended to accommodate the tenon in a tight and close fitting joint. The joint is held together by both frictional forces, and the weight and shear forces acting on the joint from outside. The joint may also be fixed by adhesives or fasteners.

FIG. 4 shows the position of the tenon on the mitered edge of a moulding. The miter shown is a typical 45 degree corner but the corner may be of any angle. The tenon 10 height dimension is perpendicular to the mitered edge when the miter is a 45 degree miter. When the miter is anything else but a 45 degree angle, the tenon should be at an angle such that it will fit the mortise to form the final angle desired of the joined structural elements. This provides that the angle compensates for the angle of the mitered edge to form a 90 degree angle, but a 90 degree angle is not always necessary for the present invention. It might be desired that the structural elements form an angle less than or greater than 90 degrees.

FIG. 5 shows the one mortise embodiment. The structural element, in this case a moulding, has a mitered edge at a substantially 45 degree angle. The mortise is also perpendicular to this edge such that it joins well with an opposing tenon.

In an alternative embodiment, the width of the tenon is narrower than the width of the mortise. This design allows for the tenon to laterally move in either direction after the tenon has been inserted into the mortise. Since doors and windows may have varying moulding widths and may not be set at perfect angles, this design solves a problem with the inconsistency of the width of the wood moulding. Wood moulding is manufactured to predefined specifications. The width and thickness should be consistent. However, the fluctuation of air temperature and humidity could change the moisture content in the wood moulding. These weather factors cause the width of the moulding to change after manufacturing. As a result, a tight fitting of the mortise and tenon does not produce a good corner joint in the case the width of the two structural elements are not the same. The edge of the two moulding structural elements are now “adjustable” and now line up after they are put together. The extra space in the mortise allows the user to move the tenon in either direction for better alignment of the two structural elements.

In an alternative embodiment, the tenon “tilts” at approximately 88 degrees (i.e., angled 88 degrees) relative to the mitered surface. The ordinary tenon is made to be perpendicular (90 degrees) relative to the mitered surface. In this embodiment, the tenon leans toward the back side of the moulding. This allows the mortise and tenon joint to fit well together and eliminate any gap between the two structural elements. This embodiment also solves a problem with the uneven surface of the areas around the window. In an ideal situation, the window jamb is installed to be flush with the wall. The window jamb and the wall are to be on the same plane. In reality, however, this ideal installation does not exist. In most installations, the window jamb is slightly higher than the surface of the wall. The wood trim is installed to cover the gap between the window jambb and the wall. The wood trim is therefore installed on an uneven surface. The uneven surface causes the corner joint to split apart after the trim is nailed onto the wall. By changing the angle of the tenon, the trim fits well on the uneven surface around the window.

The embodiments described above allow the universal joining to softwood pine mouldings where there may be uneven fluctuations in both the universal tenon joint and mortise, as well as the probable unevenness of the surface to which the product is being applied. Also the application of using double tenon or double mortises to an individual piece of trim, instead of the traditional one end mortise and one end tenon, has never been utilized in application of this joining. Heretobefore, the application of mortise and tenon has never been utilized in the universal joining of softwood pine trim mouldings. The difficulty remains with the species from which most wood mouldings are fabricated, i.e., pine, eastern white pine, ponderosa pine, Idaho white pine, and offshore radiate pine. All of these types of pine have inherent characteristics that do not lend themselves to traditional joining, including the soft loosely compressed fibers as well as the fluctuations in size of the pine species as it absorbs moisture and releases moisture to the atmosphere. These characteristics of the pine species are not found in the traditional use of joining on hardwood species.

The embodiments shown in the present figures are mouldings intended for doors or windows, however, the tenon design is not limited to that use and can be used for other structural elements. The materials from which the structural elements forming the joint of the present invention may be made include wood, plastic, concrete, rubber and other known building materials. It is preferred that the tenon be integral with the structural element however this is not necessary. For example, a mortise may be filed with a dowel or tenon element making the mortise a tenon.

Accordingly, it should be readily appreciated that the mortise and tenon joint of the present invention has many practical applications. Additionally, although the preferred embodiments have been illustrated and described, it will be obvious to those skilled in the art that various modifications can be made without departing from the spirit and scope of this invention. Such modifications are to be considered as included in the following claims.

What is claimed is:

1. A joint system for securing structural elements together comprising:
a first structural element having first and second mitered edges including a tenon on a both mitered edges of the structural element, the tenon having two opposing sloped side faces meeting at a center, and two opposing sloped end faces joining the side faces; and
a second structure element including a mortise on a mitered edge of a second structural element, the mortise oppositely corresponding to the tenon wherein the mortise receives the tenon therein;
wherein the tenon has a width that is narrower than the width of the corresponding mortise to permit the tenon to laterally move in either direction after the tenon has been inserted into the mortise.

2. The joint system as in claim 1 wherein:
the tenon is angled at approximately 88 degrees relative to the mitered surface.

3. The joint system as in claim 1 wherein:
the tenon has a glue relief on one side.

4. The joint system as in claim 1 wherein:
the end faces of the tenon is tapered.

5. The joint system as in claim 1 wherein:
the tenon is generally oval with two opposing ends, and a center portion.

6. The joint system as in claim 5 wherein:
the ends are shaped to extend in a slope upwards toward the center portion.

7. The joint system as in claim 6 wherein:
the center portion comprises opposing sides that slope up towards, and meet at a middle.

8. The joint system as in claim 1 wherein:
the first and second structural element is a moulding.

9. The joint system as in claim 8 wherein:
the moulding is softwood pine trim.

10. A method of joining two structural elements to form a joint, the method comprising the steps of:
providing a tenon at both ends of a first structural element having mitered edges;
providing a mortise on the mitered end of a second structural element and which oppositely corresponds to the tenon at the end of the first structural element;
fitting the tenon into the mortise to form an adjustable fitted joint between the first and second structural elements; and
adjusting the joint formed by the first and second structural elements so that the first and structural elements are aligned and any gap between the first and second structural elements is eliminated

11. The method as in claim 10 wherein:
the tenon on the first structural element has two opposing sloped side faces meeting at a center, and two opposing sloped end faces joining the side faces, and wherein the tenon has a width that is narrower than the width of the corresponding mortise to permit the tenon to laterally move in either direction after the tenon has been inserted into the mortise.

12. The method as in claim 10 wherein:
the tenon is angled at approximately 88 degrees relative to the mitered surface

13. The method as in claim 10 wherein:
the first and second structural element is a moulding.

14. The method as in claim 13 wherein:
the moulding is softwood pine trim.
